(19) United States
(12) Patent Application Publication
(10) Pub. No.: US 2016/0142949 A1
(43) Pub. Date: May 19, 2016

(54) RADIO COMMUNICATION SYSTEM, BASE STATION, MOBILE STATION, AND RADIO COMMUNICATION METHOD

(71) Applicant: FUJITSU LIMITED, Kawasaki-shi (JP)

(72) Inventors: Yoshiaki Ohta, Yokohama (JP); Yoshihiro Kawasaki, Kawasaki (JP); Tetsuya Yano, Yokohama (JP)

(73) Assignee: FUJITSU LIMITED, Kawasaki-shi (JP)

(21) Appl. No.: 15/001,892

(22) Filed: Jan. 20, 2016

Related U.S. Application Data
(63) Continuation of application No. PCT/JP2013/070250, filed on Jul. 25, 2013.

(51) Int. Cl. H04W 36/00; H04W 48/12; H04W 56/00; H04W 36/30; H04W 36/36

(52) U.S. Cl. CPC H04W 36/0083; H04W 36/30; H04W 36/0061; H04W 36/36; H04W 56/0015; H04W 56/0055; H04W 48/12; H04W 88/04

(57) ABSTRACT

A first radio communication device includes: a control unit that, when a second radio communication device is currently connected to the first radio communication device, notifies radio communication devices other than the first radio communication device of information on the second radio communication device; and a transmission unit that transmits, to the second radio communication device, information on the radio communication devices which have been notified of the information on the second radio communication device. The second radio communication device includes a transmission unit that selects, on the basis of the information on the radio communication devices which has been transmitted from the transmission unit of the first radio communication device, one of the radio communication devices and transmits to the selected radio communication device a control signal for controlling handover.

### CROSS-REFERENCE TO RELATED APPLICATION

This application is a continuation of International Application No. PCT/JP2013/070250, filed on Jul. 25, 2013, the entire contents of which are incorporated herein by reference.

### FIELD

The embodiments discussed herein are related to a radio communication system, a base station, a mobile station, and a radio communication method.

### BACKGROUND

Conventionally, various devices have been invented to increase a transmission capacity (hereinafter referred to as “system capacity” in some cases) in a radio communication system. For example, in 3rd Generation Partnership Project Radio Access Network Long Term Evolution (3GPP LTE), there is an ongoing discussion about techniques to increase a system capacity by utilizing “small cells” in addition to “macro cells”. Here, the term “cell” indicates a range covered by a radio base station for radio terminals to transmit and receive radio signals, and the notions of cell and radio base station substantially correspond to each other. Therefore, “cell” and “radio base station” are exchangeable in the following description as appropriate. A “macro cell” is a cell corresponding to a base station capable of transmission with high transmission power, that is, a cell having a large transmitting area. On the other hand, a “small cell” is a cell corresponding to a base station that transmits with low transmission power, that is, a cell having a small transmitting area.

Handover in LTE-A (LTE-Advance) communications is performed in the following procedure. For example, a mobile station reports radio qualities of surrounding cells to a serving base station. In this reporting, the surrounding cells subject to the measurement of radio qualities are previously designated by a serving base station. Subsequently, the serving base station carries out preparation of handover upon receiving the reporting of radio qualities. The preparation of handover includes, for example, preparation of a resource in a target base station, and forwarding of unique information (context) such as the communication capacity, the supported security, and the identification information of the mobile station. Thereafter, the serving base station instructs the mobile station to undergo handover. The mobile station is then handed over to the target base station.

There are conventional techniques by which preparation of handover at the departure side of the handover is carried out for a plurality of surrounding base stations. Such conventional techniques are described in: International Publication Pamphlet No. WO 2010/110240; TS36.211, “Physical Channels and Modulation,” V11.3.0, June 2013; TS36.212, “Multiplexing and channel coding,” V11.3.0, June 2013; TS36.213, “Physical layer procedures,” V11.3.0, June 2013; TS36.214, “Measurements,” V11.1.0, December 2012; TS36.300, “Overall description,” V11.3.0, June 2013; TS36.321, “Media Access Control (MAC) protocol specification,” V11.3.0, June 2013; TS36.322, “Radio Link Control (RLC) protocol specification,” V11.0.0, September 2012; TS36.323, “Packet Data Convergence Protocol (PDCP) specification,” V11.2.0, March 2013; and TS36.331, “Radio Resource Control (RRC) protocol specification,” V11.3.0, March 2013.

However, a mobile terminal moves even during the execution of a handover procedure. For this reason, after the measurement of radio qualities of surrounding cells, a cell having an optimal radio quality for the mobile station may possibly have changed to another cell by the time when a handover instruction is actually issued. As a consequence, the mobile station may possibly undergo handover to a cell having a poor radio quality, and the handover may possibly fail in such a case.

In addition, it has been difficult to track the movement of a mobile station while a handover procedure is being executed thereon, even by using the techniques by which preparation of handover is carried out on a plurality of surrounding base stations. It has been difficult to improve the success rate of handover.

### SUMMARY

According to an aspect of an embodiment, a radio communication system includes a plurality of first radio communication devices and a second radio communication device. The first radio communication devices each includes: a control unit that, when the second radio communication device is currently connected to the first radio communication device which has the control unit, notifies the first radio communication devices other than the first radio communication device of information on the second radio communication device; and a first transmission unit that transmits, to the second radio communication device, information on the first radio communication devices which have been notified of the information on the second radio communication device. The second radio communication device includes: a second transmission unit that selects, on the basis of the information on the first radio communication devices which has been transmitted from the first transmission unit, one of the first radio communication devices which have been notified of the information on the second radio communication device and transmits to the selected first radio communication device a control signal for controlling handover.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a radio communication system according to a first embodiment;

FIG. 2 is a sequence diagram of operations of devices in the radio communication system according to the first embodiment;

FIG. 3 is a flowchart of a handover process in the radio communication system according to the first embodiment;

FIG. 4 is a block diagram of a radio communication system according to a second embodiment;

FIG. 5 is a diagram of one example of RRC Connection Reconfiguration with Mobility Control Info after processing;

FIG. 6 is a sequence diagram of a handover process in the radio communication system according to the second embodiment;

FIG. 7 is a flowchart of a handover process in a mobile station and a base station of the radio communication system according to the second embodiment;

FIG. 8 is a hardware configuration diagram of a base station;

FIG. 9 is a hardware configuration diagram of a communication terminal;

FIG. 10 is a schematic configuration diagram of a radio communication system according to a third embodiment; and

FIG. 11 is a block diagram of the radio communication system according to the third embodiment.

### DESCRIPTION OF EMBODIMENTS

Preferred embodiments of the present invention will be explained with reference to accompanying drawings. However, the following embodiments are not intended to limit the radio communication system, the base station, the mobile station, and the radio communication method disclosed herein.

### [a] First Embodiment

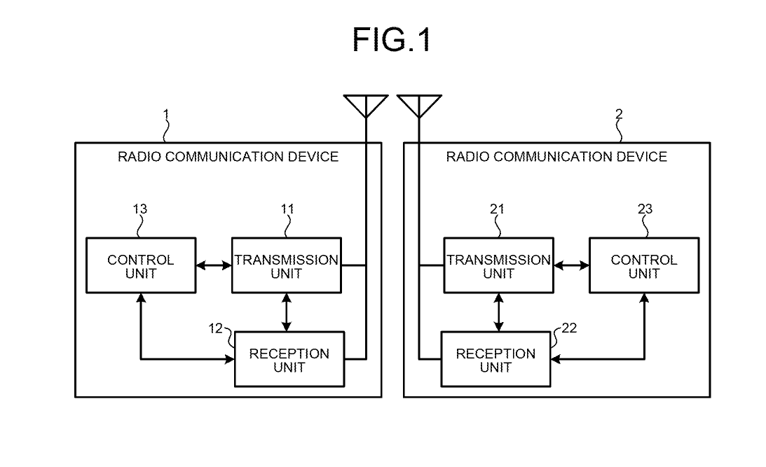

FIG. 1 is a block diagram of a radio communication system according to the first embodiment. FIG. 1 illustrates only one radio communication device 1; however, a plurality of radio communication devices 1 have been deployed. A radio communication device 2 moves through communication ranges of the respective radio communication devices 1. The radio communication device 2 is currently connected to any one of the radio communication devices 1, and is to be handed over from the currently connected radio communication device 1 to the next one of the radio communication devices 1.

Each of the radio communication devices 1 includes a transmission unit 11, a reception unit 12, and a control unit 13.

The control unit 13 of the radio communication device 1 currently connected to the radio communication device 2 acquires a radio quality between the radio communication device 2 and each of the radio communication devices 1 surrounding the radio communication device 2.

The control unit 13 then selects, on the basis of the acquired radio qualities, the radio communication devices 1 that are potential handover destinations of the radio communication device 2.

The control unit 13 transmits information on the radio communication device 2 to the selected radio communication devices 1 via the transmission unit 11.

Thereafter, the control unit 13 receives via the reception unit 12, from the radio communication devices 1 to which the information on the radio communication device 2 has been transmitted, information as to whether it can accept the handover. For example, the control unit 13 receives, from the radio communication devices 1 that have accepted the handover of the radio communication device 2, notification of their approval of the acceptance.

The control unit 13 then transmits to the radio communication device 2, via the transmission unit 11, information on the radio communication devices 1 that have transmitted notification of their approval of the acceptance.

The radio communication device 2 includes a transmission unit 21, a reception unit 22, and a control unit 23.

The control unit 23 measures, at regular time intervals, a radio quality between the radio communication device 2 of this control unit 23 and each of the radio communication devices 1 surrounding this radio communication device 2.

The reception unit 22 receives the information on the radio communication devices 1 that has been transmitted from the control unit 13 of the radio communication device 1. The reception unit 22 then transmits the received information on the radio communication devices 1 to the transmission unit 21.

The transmission unit 21 then receives the information on the radio communication devices 1 from the reception unit 22. The transmission unit 21 further receives the most recent information on the radio qualities from the control unit 23. Subsequently, the transmission unit 21 selects, from the radio communication devices 1 designated in the received information, a radio communication device 1 that has a high radio quality. For example, the transmission unit 21 selects a radio communication device 1 that has the highest radio quality. In another example, the transmission unit 21 may select a radio communication device 1 that does not have the highest radio quality but has a broad downlink transmission bandwidth and is expected to provide a high throughput and a high quality of service (QoS). The transmission unit 21 then transmits to the selected radio communication device 1 a control signal for controlling the handover.

Thereafter, the radio communication device 2 is handed over from the currently connected radio communication device 1 to the radio communication device 1 to which the control signal has been transmitted, and is connected to the radio communication device 1 to which the control signal has been transmitted.

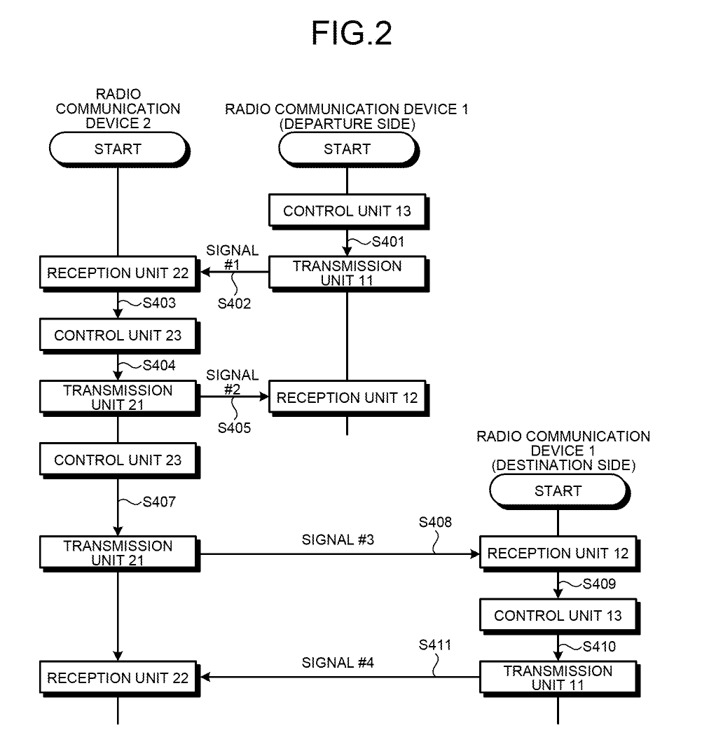

Next, operations of devices in the radio communication system according to the present embodiment are described with reference to FIG. 2. FIG. 2 is a sequence diagram of operations of devices in the radio communication system according to the first embodiment.

The control unit 13 of the radio communication device 1 of the departure side in handover instructs the transmission unit 11 to transmit information on the radio communication devices 1 that have transmitted notification of approval of their acceptance of the handover (Step S401).

The transmission unit 11 transmits a signal #1 to the reception unit 22 (Step S402). The signal #1 is, for example, a signal containing information on the radio communication devices 1 that have transmitted notification of their approval of acceptance of the handover, and this signal is, for example, a list of handover destination candidates.

The reception unit 22 of the radio communication device 2 notifies the control unit 23 of its reception of the signal #1 (Step S403).

The control unit 23 instructs the transmission unit 21 to execute response to the signal #1 (Step S404)

The transmission unit 21 transmits the signal #2 to the radio communication device 1 of the departure side (Step S405). The signal #2 is, for example, ACK or the like.

Thereafter, the control unit 23 instructs the transmission unit 21 to transmit a handover control signal to a radio communication device 1 of the destination side (Step S407).

The transmission unit 21 selects, as the radio communication device 1 of the destination side, a radio communication device 1 that has the highest radio quality among the radio communication devices 1 designated in the signal #1, and transmits a signal #3 to the radio communication device 1 of the destination side (Step S408). The signal #3 is, for example, a signal for notification indicating that the handover destination has been determined, and this signal is a control signal for controlling handover to a radio communication device 1 of the destination side.

The reception unit 12 of the radio communication device 1 of the destination side notifies the control unit 13 that the signal #3 has been received (Step S409).

The control unit 13 instructs the transmission unit 11 to execute response to the signal #3 (Step S410).

The transmission unit 11 transmits a signal #4 to the reception unit 22 of the radio communication device 2 (Step S411). Here, the signal #4 is, for example, notification of approval of handover.

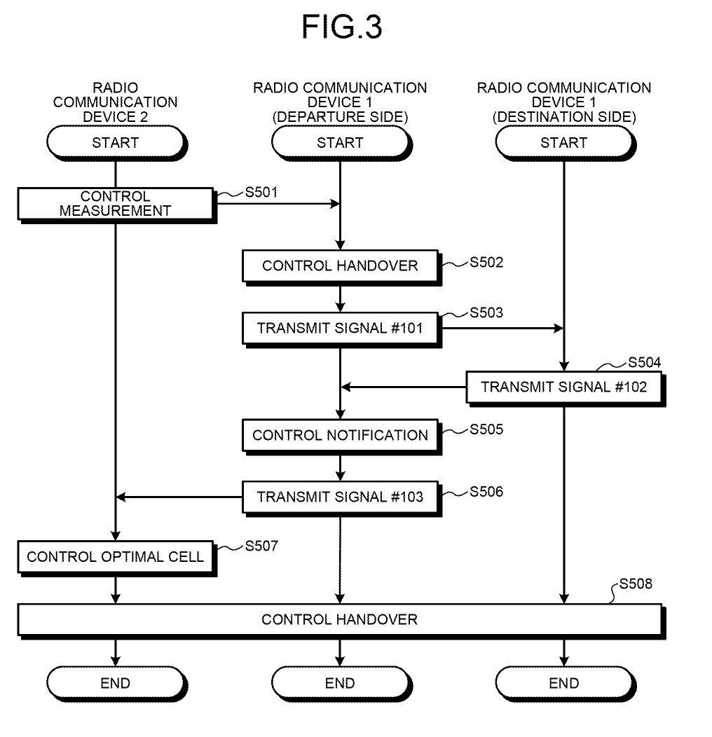

Next, a procedure of a handover process in the radio communication system according to the present embodiment is described with reference to FIG. 3. FIG. 3 is a flowchart of the handover process in the radio communication system according to the first embodiment.

The control unit 23 of the radio communication device 2 performs measurement control (Step S501). The measurement control includes, for example, measurement of a reception quality between the radio communication device 2 and each of the radio communication devices 1. The control unit 23 then transmits measured reception qualities to the radio communication device 1 of the departure side.

The control unit 13 of the radio communication device 1 of the departure side performs handover control (Step S502). The handover control includes, for example, determination as to whether the handover has been started, and instruction of transmission of context.

The transmission unit 11 of the radio communication device 1 of the departure side transmits a signal #101 to radio communication devices 1 that are candidates for the destination side (Step S503). The signal #101 is, for example, context or the like.

The transmission unit 11 of each of the radio communication devices 1 that are candidates for the destination side transmits a signal #102 to the radio communication device 1 of the departure side (Step S504). The signal #102 is notification of acceptableness, or the like.

The control unit 13 of the radio communication device 1 of the departure side performs notification control (Step S505). Here, the notification control includes, for example, modifying a message for notification of information on the radio communication device 1 that is a candidate for the destination side.

The transmission unit 11 of the radio communication device 1 of the departure side transmits a signal #103 to the radio communication device 2 (Step S506). The signal #103 is a list of handover destination candidates, or the like.

The control unit 13 and the transmission unit 11 of the radio communication device 2 perform optimal-cell control (Step S507). The optimal-cell control is, for example, control for finding out an optimal cell and determining a radio communication device 1 of the destination side.

Thereafter, the radio communication device 2, the radio communication device 1 of the departure side, and the radio communication device 1 of the destination side work harmoniously with one another to perform handover control (Step S508). The handover control includes, for example, transmission of a handover request, notification of approval of handover, execution of handover, and release of resource.

### [b] Second Embodiment

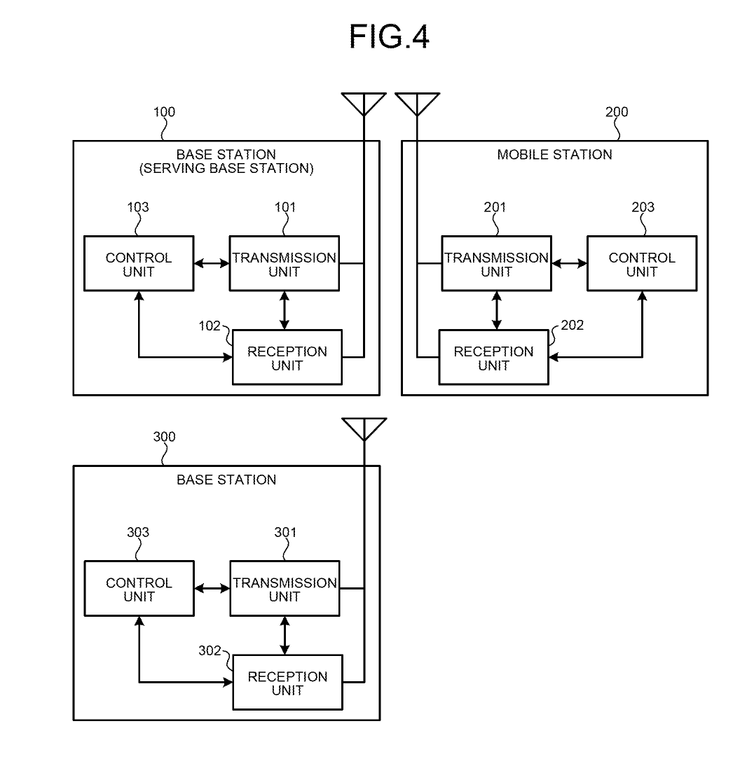

FIG. 4 is a block diagram of a radio communication system according to a second embodiment. Obviously, the present embodiment can be implemented in combination with the first embodiment. A base station 100 and a base station 300 correspond to the radio communication devices 1 in the first embodiment. The base station 300 is a base station other than a serving base station. A mobile station 200 corresponds to the radio communication device 2 in the first embodiment.

The base station 100 is currently connected to the mobile station 200, and is a serving base station from which the mobile station 200 is handed over. More specifically, the present embodiment exemplifies a case of handover where the mobile station 200 is disconnected from the base station 100 currently connected thereto and then connected to the base station 300.

The base station 100 includes a transmission unit 101, a reception unit 102, and a control unit 103.

The control unit 103 receives from the mobile station 200, via the reception unit 102, the result of measurement of a radio quality between the mobile station 200 and each of the base stations 300 surrounding the mobile station 200. For example, channel quality information (CQI) representing a downlink radio quality measured by a mobile station, and a sounding reference signal (SRS) representing an uplink radio quality, which are called uplink channel information (UCI), correspond to the radio quality.

The control unit 103 then selects, as destination-side candidate base stations, the base stations 300 that correspond to results, among the received results of measurement of radio qualities, that are higher than a certain threshold. The control unit 103 transmits unique information (context) of the mobile station 200 to the base stations 300 selected as the destination-side candidate base stations. Here, the context contains such information as the communication capacity, the supported security, and the identification information of the mobile station 200. This context represents one example of “information on a second radio communication device.” The destination-side candidate base stations to which the context is transmitted represent one example of “the first radio communication devices other than the foregoing one of the first radio communication devices.”

Thereafter, when any base station 300 selected as the destination-side candidate base station has approved its acceptance of handover of the mobile station 200, the control unit 103 receives from the base station 300 having approved its acceptance of the handover, via the reception unit 102, notification of its acceptance of the handover. The control unit 103 further receives, from the base station 300 having approved its acceptance of the handover, receives acceptance-approving base station information. The acceptance-approving base station information is, for example, information such as RRC Connection Reconfiguration with MobilityControlInfo. RRC Connection Reconfiguration with MobilityControlInfo is information that has an information element “MobilityControlInfo” contained in a radio resource control (RRC) message known as “RRC Connection Reconfiguration.” MobilityControlInfo contains, for example, the cell ID (TargetPhysCellID), the frequency (CarrierFreq), and the bandwidth (carrierBandwidth) of the destination-side base station, and an identifier (newUE-Identity) assigned to the mobile station 200. MobilityControlInfo further contains radio parameter information (radioResoruceConfigCommon) that is common to cells.

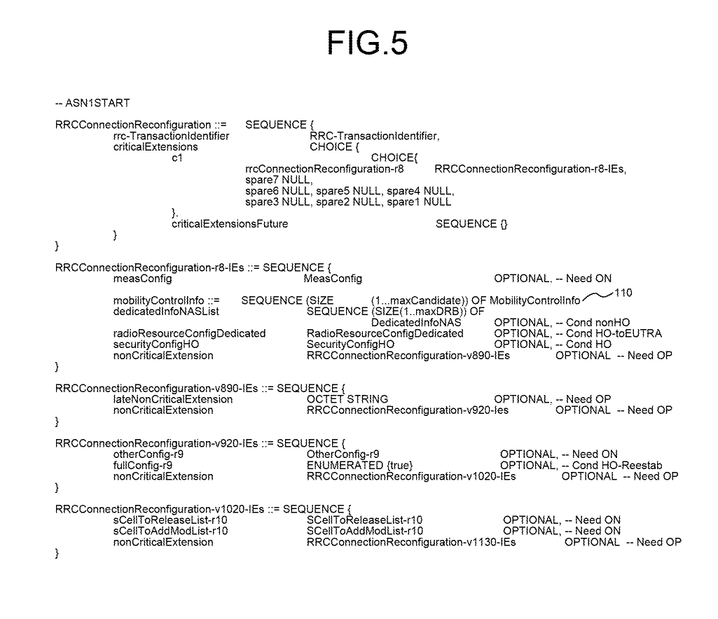

Subsequently, the control unit 103 processes (aggregates, edits, modifies, or couples together) individual pieces of acceptance-approving base station information that have been received, thereby generating a single piece of destination-side candidate base station information indicating all of the base stations 300 that are destination-side candidate base stations having approved their acceptance of the handover. For example, the control unit 103 generates, as the destination-side candidate base station information, RRC Connection Reconfiguration with MobilityControlInfo as illustrated in FIG. 5. FIG. 5 is a diagram of one example of RRC Connection Reconfiguration with MobilityControlInfo after the modification. MobilityControlInfo illustrated in a line 110 in FIG. 5 is generated correspondingly to the number of base stations 300 selected as destination-side candidates. However, FIG. 5 is one example of RRC Connection Reconfiguration with MobilityControlInfo, and RRC Connection Reconfiguration with MobilityControlInfo is not particularly limited as long as the message structure thereof can convey information on the destination-side candidates.

Here, in the present embodiment, the control unit 103 aggregates the pieces of acceptance-approving base station information received from the respective base stations 300 selected as the destination-side candidate base stations. However, this is not a limiting example. For example, the control unit 103 may transparently transmit to the mobile station 200 the pieces of acceptance-approving base station information received from the respective base stations 300 selected as the destination-side candidate base stations, as they are (without processing, editing, modifying, coupling together, and aggregating these pieces of information).

Aggregating the pieces of acceptance-approving base station information is advantageous in that messages corresponding to these pieces can be transmitted at one time. In contrast, when the pieces of acceptance-approving base station information are not aggregated, the end-to-end relations of RRC are maintained, and the independence of the messages is maintained. In addition, when the pieces of acceptance-approving base station information are not aggregated, a processing load on the base station 100 is reduced.

The transmission unit 101 transmits data to the mobile station 200 and the base stations 300 by radio.

The transmission unit 101 transmits, to the mobile station 200, the destination-side candidate base station information generated by the control unit 103. The transmission unit 101 thus transmits, to the mobile station 200, information on the base stations 300 selected as the destination-side candidate base stations. This destination-side candidate base station information for notification of the destination-side candidate base stations represents one example of “information on first radio communication devices.”

The reception unit 102 receives data from the mobile station 200 and the base stations 300 by radio.

Each of the base stations 300 includes a transmission unit 301, a reception unit 302, and a control unit 303.

When one of the base stations 300 has been selected by the base station 100 as a destination-side candidate base station, the control unit 303 thereof receives the context of the mobile station 200 from the base station 100 via the reception unit 302. The control unit 303 then determines, on the basis of current situations (such as the number of currently connected mobile stations) of the corresponding base station 300, whether handover of the mobile station 200 can be accepted. If the handover can be accepted, the control unit 303 transmits to the base station 100, via the transmission unit 301, notification of acceptance of the handover.

The control unit 303 further transmits destination-side candidate base station information to the base station 100.

Thereafter, if the base station 300 of the control unit 303 is selected as a destination-side base station in the handover of the mobile station 200, the control unit 303 is notified by the reception unit 302 that a handover request from the mobile station 200 has been received. The control unit 303 then determines, on the basis of current situations of the corresponding base station 300, whether handover of the mobile station 200 can be accepted. Subsequently, if the handover can be accepted, the control unit 303 notifies the transmission unit 301 that the handover has been approved.

The transmission unit 301 transmits data to the base stations 100 and the mobile station 200 by radio.

When the control unit 303 approves the handover after the base station 300 thereof is selected as the destination-side base station in the handover of the mobile station 200, the transmission unit 301 is notified by the control unit 303 that the handover is approved. The transmission unit 301 then transmits notification of its approval of the handover to the mobile station 200.

Subsequently, the transmission unit 301 receives notification of completion of the handover from the reception unit 302. The transmission unit 301 then transmits notification of resource release to the base station 100.

The reception unit 302 receives data from the base station 100 and the mobile stations 200 by radio.

When the corresponding base station 300 is selected as a destination-side base station in handover of the mobile station 200, the reception unit 302 receives a handover request from the mobile station 200. The reception unit 302 then notifies the control unit 303 that the handover request has been received.

Subsequently, the reception unit 302 receives notification of completion of the handover from the mobile station 200. The reception unit 302 then notifies the transmission unit 301 that the handover has been completed.

The mobile station 200 includes a transmission unit 201, a reception unit 202, and a control unit 203.

The control unit 203 measures, at regular time intervals, a communication quality between the mobile station 200 and each of the surrounding base stations 300 by using, for example, a signal received by the reception unit 202 from the base stations 300. The control unit 203 then transmits results of measurement of the communication qualities to the transmission unit 201. The control unit 203 represents one example of a “measurement unit”.

The transmission unit 201 transmits data to the base station 100 and the base stations 300 by radio.

The transmission unit 201 transmits at regular time intervals, to the base station 100, results of measurement of the communication quality between the mobile station 200 and each of the surrounding base stations 300 that has been received from the control unit 203.

Furthermore, the transmission unit 201 acquires, from the reception unit 202, information on the base stations 300 that are destination-side candidate base stations. The transmission unit 201 then selects, from the destination-side candidate base stations, a base station 300 having a high measurement result of the communication quality as a base station of the destination-side in the handover. The transmission unit 201 then transmits a handover request to the base station 300 selected as the destination-side base station. Thereafter, upon receiving from the reception unit 202 notification of approval of the handover, the transmission unit 201 transmits a notification of a completion of handover to the base station 300 that is the destination-side base station.

In the present embodiment, in order that handover is reliably performed, the transmission unit 201 transmits a handover request to and receives approval of handover from the base station 300 that is the destination-side base station. However, handover can be carried out without these transmission and reception.

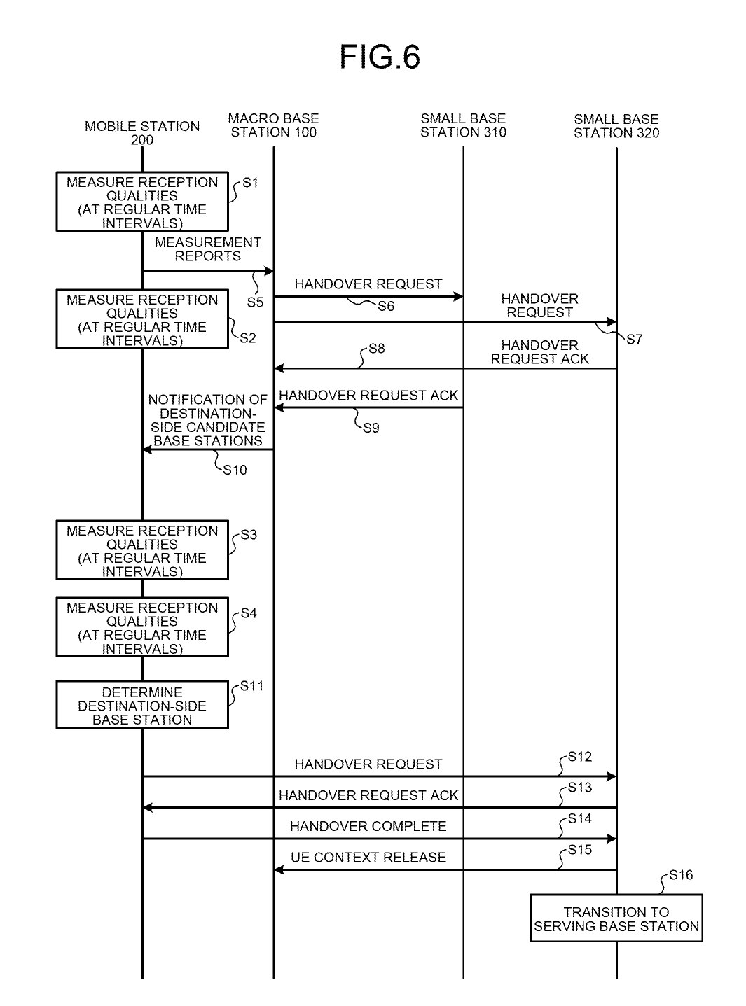

Next, the entire procedure of the handover process in the radio communication system according to the present embodiment is described with reference to FIG. 6. FIG. 6 is a sequence diagram of the handover process in the radio communication system according to the second embodiment. In FIG. 6, the base station 100 is currently being connected to the mobile station 200, and is a serving base station from which the mobile station 200 is handed over. Here, a case is described where base stations 310 and 320 are selected from the base stations 300 as destination-side candidate base stations by the base station 100. FIG. 6 illustrates the passage of time in the downward direction.

The mobile station 200 measures reception qualities at regular time intervals (Steps S1, S2, S3, and S4).

The mobile station 200 then transmits Measurement Reports (results of measurement of reception qualities) to the serving base station at regular time intervals. Here, the mobile station 200 transmits the Measurement Reports to the base station 100 (Step S5).

The base station 100 selects, from the results of measurement of reception qualities received from the mobile station 200, measurement results that are higher than a certain threshold, and specifies the base stations 300 that correspond to the selected measurement results as destination-side candidate base stations. Here, the base station 100 specifies the base station 310 and the base station 320 as the destination-side candidate base stations. The base station 100 then transmits (forwards) a Handover Request (a signal for forwarding context in a handover (HO) request) regarding the mobile station 200 to the base station 310 (Step S6). The base station 100 also transmits (forwards) a Handover Request (a handover (HO) request; a signal containing the context) regarding the mobile station 200 to the base station 320 (Step S7).

The base station 320 transmits a Handover Request Ack (notification of it acceptance of handover of the mobile station 200) to the base station 100 operating as the serving base station (Step S8). Likewise, the base station 310 transmits a Handover Request Ack (notification of it acceptance of handover of the mobile station 200) to the base station 100 operating as the serving base station (Step S9). When transmitting the notification, the base stations 310 and 320 transmit acceptance-approving base station information (for example, RRC Connection Reconfiguration with MobilityControlInfo) to the base station 100.

The base stations 100 receive the acceptance-approving base station information from the base stations 310 and 320. The base station 100 then modifies the received acceptance-approving base station information, thereby generating destination-side candidate base station information (for example, RRC Connection Reconfiguration with MobilityControlInfo) notifying that the base stations 310 and 320 are destination-side candidate base stations. Subsequently, the base station 100 transmits the generated destination-side candidate base station information to the mobile station 200, thereby notifying the mobile station 200 of the destination-side candidate base stations (Step S10).

The mobile station 200 determines, by using the most recent results of measurement of reception qualities, a destination-side base station that is to be a handover destination, from the destination-side candidate base stations indicated by the notification from the base station 100 (Step S11). For example, in Step S11, the mobile station 200 determines, as the destination-side base station, the base station 300 that corresponds to a high radio quality among the measurement results obtained at Step S4. This is because the measurement results obtained in the measurement at Step S4 are the most recent measurement results. The present embodiment assumes that the mobile station 200 determines the base station 320 as the destination-side base station.

The mobile station 200 transmits a Handover Request (a handover (HO) request) to the base station 320 determined to be the destination-side base station (Step S12).

Upon receiving the Handover Request, the base station 320 determines whether to approve the handover, and, if approving the handover, notifies the mobile station 200 of a Handover Request Ack (notification of approval of handover (HO)) (Step S13).

Upon receiving the notification of approval of handover, the mobile station 200 executes the handover. Thereafter, the mobile station 200 transmits a Handover Complete (notification of completion of handover (HO)) to the base station 320 (Step S14).

Upon receiving an End Marker, the base station 320 transmits a UE Context Release (notification of release of a resource assigned to the mobile station 200) to the base station 100 of the departure side in the handover (Step S15). The base station 320 then transitions to a serving base station that provides communication to the mobile station 200 (Step S16).

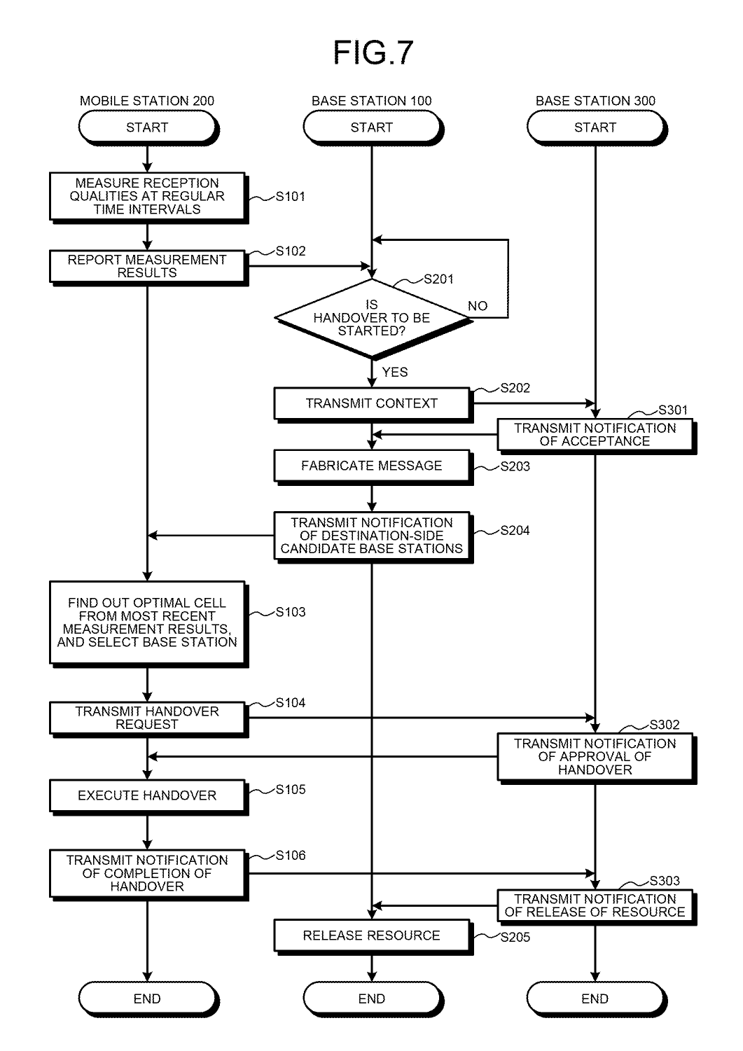

Furthermore, the handover process in a mobile station and a base station of the radio communication system according to the present embodiment is described with reference to FIG. 7. FIG. 7 is a flowchart of the handover process in a mobile station and a base station of the radio communication system according to the second embodiment. The following describes the procedure of the process with respect to each device. The description herein assumes that the base station 100 and the base station 300 are a serving base station and a destination-side base station in handover, respectively.

Firstly, the process in the mobile station 200 is described. The mobile station 200 measures reception qualities at regular time intervals (Steps S101).

The mobile station 200 then reports results of measurement of reception qualities to the base station 100 (Step S102).

Thereafter, when the handover is started, the mobile station 200 receives notification indicating destination-side candidate base stations from the base station 100 operating as the serving base station. The mobile station 200 then finds out an optimal cell on the basis of the most recent measurement results of reception qualities, and selects the base station 300, which is the destination-side base station (Step S103).

The mobile station 200 transmits a handover request to the base station 300 selected as the destination-side base station (Step S104).

Thereafter, upon receiving notification of approval of handover from the base station 300, which is the destination-side base station, the mobile station 200 executes the handover, and is newly connected to the base station 300, which is the destination-side base station (Step S105).

The mobile station 200 then notifies the base station 300, which is the destination-side base station, of completion of handover (Step S106). Thereafter, the mobile station 200 continues communication while having the base station 300, which is the destination-side base station, as the serving base station.

Next, the base station 100 operating as the serving base station is described.

The base station 100 regularly receives measured reception qualities from the mobile station 200. The base station 100 then determines whether to start handover of the mobile station 200 (Step S201). If the handover is not started (No at Step S201), the base station 100 waits until the start of handover.

On the other hand, if the handover is started (Yes at Step S201), the base station 100 selects destination-side candidate base stations on the basis of the received results of measurement of reception qualities. Then, the base station 100 transmits (forwards) context of the mobile station 200 to the base station 300, which is the destination-side candidate base station (Step S202).

Thereafter, upon receiving, from the destination-side candidate base stations, notification of their acceptance of the handover, the base station 100 modifies acceptance-approving base station information received from the respective base stations 300, which are destination-side candidate base stations, and thereby generates destination-side candidate base station information (Step S203).

The base station 100 then transmits the generated destination-side candidate base station information to the mobile station 200, thereby notifying the mobile station 200 of destination-side candidate base stations (Step S204).

Thereafter, upon receiving notification of resource release from the base station 300 determined to be the destination-side base station by the mobile station 200, the base station 100 releases a resource assigned to the mobile station 200 (Step S205).

Next, the base station 300 to be selected as the destination-side base station is described.

After being selected by the base station 100 as a destination-side candidate base station, the base station 300 receives context of the mobile station 200 from the base station 100.

The base station 300 then determines whether it can accept handover of the mobile station 200, and, if it can accept the handover, transmits to the base station 100 notification indicating that it can accept the handover (Step S301).

Furthermore, after being determined to be the destination-side base station by the mobile station 200, the base station 300 receives a handover request from the mobile station 200. The base station 300 then determines whether it can accept handover of the mobile station 200, and, if it can accept the handover, transmits notification of approval of handover to the mobile station 200 (Step S302).

Thereafter, upon receiving notification of handover completion from the mobile station 200, the base station 300 notifies the base station 100 of the departure side in the handover of resource release (Step S303). From that time on, the base station 300 operates as a serving base station for the mobile station 200.

Hardware Configuration

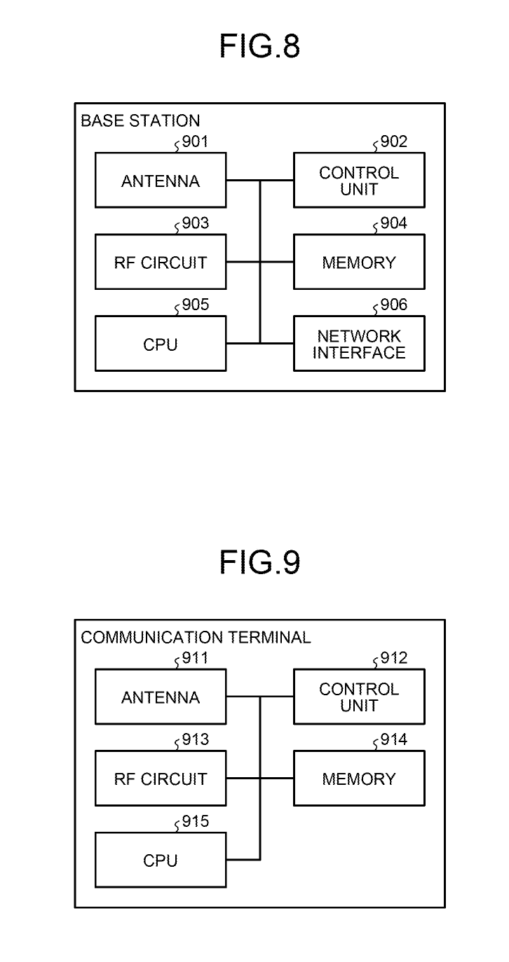

FIG. 8 is a hardware configuration diagram of a base station. Examples of the base station include the radio communication device 1 illustrated in FIG. 1 and the base stations 100 and 300 illustrated in FIG. 4.

The base station includes an antenna 901, a control unit 902, an RF circuit 903, a memory 904, a central processing unit (CPU) 905, and a network interface 906.

The control unit 902 implements, for example, the functions of the control unit 13 illustrated in FIG. 1 and FIG. 4.

The network interface 906 is an interface used for connecting a cable-linked network. For example, the base station 100 and the base station 300 may be connected via the network interfaces 906.

The CPU 905, the memory 904, and the RF circuit 903 implement the functions of the transmission unit 11 and the reception unit 12 illustrated in FIG. 1, or the functions of the transmission units 101 and 201 and the reception units 102 and 202 illustrated in FIG. 4.

For example, the memory 904 has various computer programs stored thereon including computer programs that implement the functions of the transmission unit 11 and the reception unit 12, the functions of the transmission units 101 and 201, or the functions of the reception units 102 and 202.

The CPU 905 implements the various functions by reading out the computer programs stored in the memory 904 and working harmoniously with such components as the RF circuit 903.

FIG. 9 is a hardware configuration diagram of a communication terminal. Examples of the communication terminal in FIG. 9 include the radio communication device 2 in FIG. 1 and the mobile station 200 illustrated in FIG. 4.

The mobile station includes an antenna 911, a control unit 912, an RF circuit 913, a memory 914, and a CPU 915.

The control unit 912 implements, for example, the functions of the control unit 13 in FIG. 1 and the control units 103 and 303 in FIG. 4.

The CPU 915, the memory 914, and the RF circuit 913 implement the functions of the transmission unit 11 and the reception unit 12 in FIG. 1, or the functions of the transmission units 101 and 301 and the reception units 102 and 302 in FIG. 4.

For example, the memory 914 has various computer programs stored thereon including computer programs that implement the functions of the transmission unit 11 and the reception unit 12, or the functions of the transmission units 101 and 301 and the reception units 102 and 302.

The CPU 915 implements the various functions by reading out the computer programs stored in the memory 914 and working harmoniously with such components as the RF circuit 913.

As described above, in the radio communication system according to the present embodiment, a serving base station selects base stations that are candidates for the destination side in handover and inform a mobile station thereof, and the mobile station finds out an optimal cell, selects the destination-side base station, and enters into execution of handover. The mobile station thus can use the most-recently measured reception qualities in determining the destination-side base station and can appropriately determine the handover destination. The radio communication system according to the present embodiment can improve the success rate of handover.

### [c] Third Embodiment

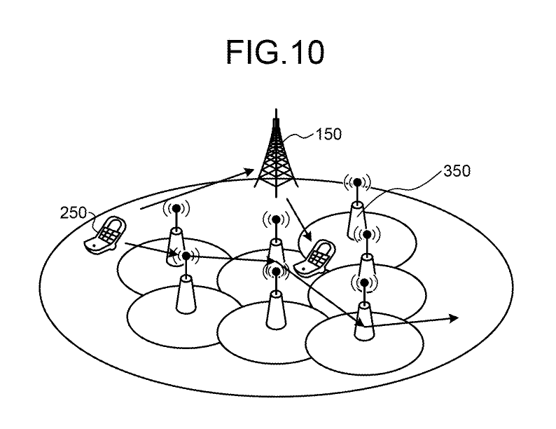

FIG. 10 is a schematic configuration diagram of a radio communication system according to a third embodiment. The radio communication system according to the present embodiment includes, as illustrated in FIG. 10, a macro base station 150, small base stations 350, and a mobile station 250. A macro cell, which is a cell of the macro base station 150, contains small cells, which are cells of the base stations 350. In the present embodiment, the mobile station 250 is connected to the macro base station 150 or any one of the small base stations 350 in a multiple-access configuration. In the following description, a dual-access configuration is taken as an example of a multiple-access configuration. Obviously, the present embodiment can be implemented in combination with the first embodiment or the second embodiment.

Firstly, a brief description is given of how to implement a dual-access configuration. Consideration is now given to carrier aggregation (CA), which is a technique specified in a conventional LTE system. The carrier aggregation allows for high-speed and large-capacity communication by using a bundle of a plurality of component carriers (CCs) each being a frequency band to be used in communication between a radio base station and a radio terminal. While a bandwidth supported by an LTE system is limited to the maximum of 20 MHz, introduction of the carrier aggregation enables, for example, the use of a bandwidth of 40 MHz with two CCs each having 20 MHz used in a bundle.

Within the framework of the carrier aggregation, implementation of a dual-access configuration seems possible, for example, by having a macro cell use one CC and having a small cell use the other CC. However, implementing a dual-access configuration on the basis of the carrier aggregation is difficult for the following reason.

Here, consideration is given to the carrier aggregation in view of a protocol stack in an LTE system. A protocol stack in an LTE system has a physical (PHY) layer, a media access control (MAC) layer, a radio link control (RLC) layer, and a packet data convergency protocol (PDCP) layer in order from the lowest layer (the other layers at higher levels are omitted here). In view of their correspondence to the Open Systems Interconnection (OSI) reference model, the PHY layer in an LTE system corresponds to a physical layer, which is Layer 1, in the OSI reference model. The MAC layer, the RLC layer, and the PDCP layer in an LTE system correspond to a data link layer, which is Layer 2, in the OSI reference model. The MAC layer is responsible for functions such as a scheduler function; the RLC layer is responsible for functions such as sequence control; and the PDCP layer is responsible for functions such as security.

When being considered in view of a protocol stack in an LTE system, the carrier aggregation is considered as a technique by which data to be transmitted is divided in the physical layer. It is also considered as a technique by which received data is integrated in the physical layer. This means that the carrier aggregation works with a plurality of entities for a physical layer and one entity for each of the upper layers such as a MAC layer in each of the transmission and reception sides. Here, an entity is a term meaning a logical (or virtual) subject that executes processing. Entities exist in the individual layers of a protocol stack, and are not necessarily in a one-to-one correspondence, but may be in an N-to-one correspondence with a device that is a physical subject that executes processing. For example, as described above, when the carrier aggregation is applied, there are a plurality of entities for a physical layer in each of the transmission and reception sides.

Here, in a protocol stack in general data communication in an LTE system, respective entities of the PHY layer, the MAC layer, the RLC layer, and the PDCP layer operate in one straight line both in each radio base station and in each radio terminal.

In data communication based on the carrier aggregation in an LTE system, respective entities of the PHY layer, the MAC layer, the RLC layer, the PDCP layer also operate both in each radio base station and in each radio terminal. Data communication based on the carrier aggregation, however, is different from general data communication in an LTE system in that the physical layer has two separate entities. Thus, when being considered in view of a protocol stack in an LTE system, the carrier aggregation is considered as a technique by which data to be transmitted is divided in the PHY layer and also as a technique by which received data is integrated in the PHY layer.

As described above, the MAC layer in an LTE system is responsible for a scheduler function. A scheduler function is a function for determining when and at what frequency to transmit data. The above-mentioned point that the MAC layer has one entity in the carrier aggregation means that there is only one scheduler.

Assuming that an attempt to implement a dual-access configuration using the carrier aggregation is made, an MAC entity (scheduler) existing in a macro radio base station has to perform scheduling for PHY entities (CCs) that exist in the macro radio base station and a small radio base station, respectively. Such implementation is difficult because of a latency issue in communication between radio base stations. The latency issue arises from the need to perform scheduling in an LTE system at very minute intervals in the units of milliseconds (each corresponding to one sub-frame). Therefore, although the carrier aggregation allows one radio base station to perform transmission and reception using a plurality of carriers, it is not considered realistic that a plurality of radio base stations perform transmission and reception using a plurality of carriers. From the above consideration, implementation of a dual-access configuration using the carrier aggregation is considered difficult.

On the basis of the above-described consideration of the carrier aggregation, implementation of a dual-access configuration necessitates separation of data in the data link layer above the physical layer. As described above, in an LTE system, the data link layer is further divided into three layers, which are the MAC layer, the RLC layer, and the PDCP layer. For example, separation of data in the MAC layer increases the number of entities of the MAC layer to two or more. The separation consequently increases the number of schedulers to two or more, and, for example, respective separate schedulers are provided to the macro radio base station and the small radio base station. Separation of data in the MAC layer therefore can eliminate the above-described latency issue in communication between radio base stations, thereby enabling implementation of a dual-access configuration. Likewise, separation of data in the RLC layer and in the PDCP layer enables implementation of a dual-access configuration.

Note that separation of data in the data link layer is not equivalent to a dual access configuration. This is because there are cases where a single-access configuration is constructed even with data separated in the data link layer, such as a case where one radio base station has two or more MAC entities.

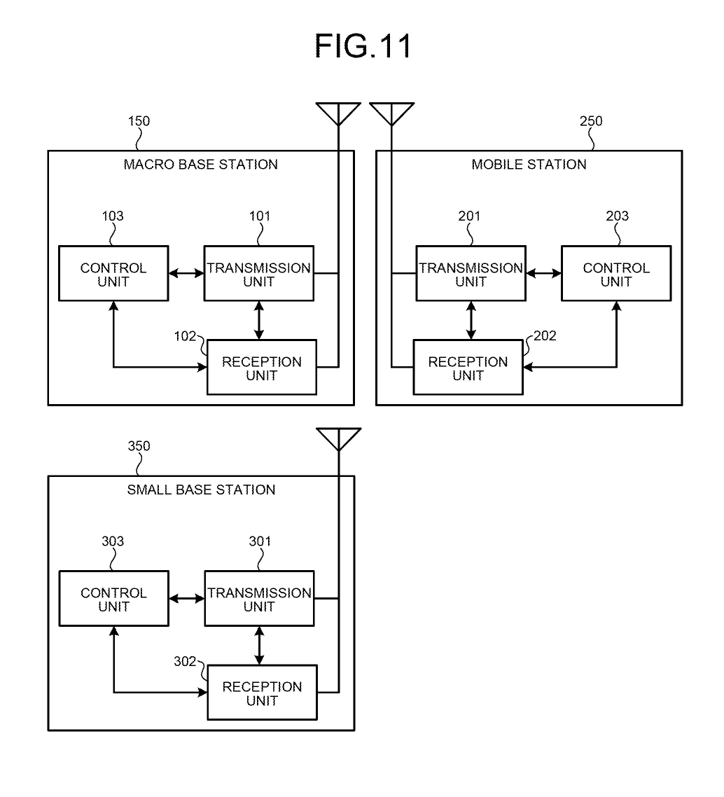

FIG. 11 is a block diagram of the radio communication system according to the third embodiment. The radio communication system according to the present embodiment includes a macro base station 150, a mobile station 250, and a small base station 350.

The macro base station 150 includes a transmission unit 101, a reception unit 102, and a control unit 103. The mobile station 250 includes a transmission unit 201, a reception unit 202, and a control unit 203. The small base station 350 includes a transmission unit 301, a reception unit 302, and a control unit 303. Here, the individual units having the same reference signs as those in FIG. 4 have the same functions as theirs.

The present embodiment is described by way of an exemplary case where the mobile station 250 executes handover starting from a state connected to the macro base station 150 acting as the primary base station and the small base station 350 acting as the secondary base station in a dual-access manner, and thus transitions into a state having the small base station 350 as the primary base station. Note that the situation of handover given in this description is merely an example. Handover is not limited to this exemplary situation, and the mobile station 250 may be handed over to another one of the macro base stations 150. Alternatively, the mobile station 200 may be handed over in a situation where the primary base station is connected thereto as one of the small base station 350 in a dual-access manner.

The control unit 103 of the macro base station 150 regularly receives results of measurement of reception qualities from the mobile station 250.

When then handing over the mobile station 250, the control unit 103 selects small base stations 350 as destination-side candidate base stations on the basis of the received results of measurement. Here, for example, if another one of the macro base stations 150 has been selected as a destination-side candidate, the control unit 103 also selects this macro base station 150 as a destination-side candidate base station.

The control unit 103 transmits context of the mobile station 250 to the small base stations 350 that are destination-side candidate base stations. The control unit 103 then receives, from the small base stations 350 that are destination-side candidate base stations, notification of approval of their acceptance of handover of the mobile station 250. Subsequently, the control unit 103 modifies received messages, thereby generating a message indicating all of the small base stations 350 that are destination-side candidate base stations.

The transmission unit 101 transmits the message generated by the control unit 103 to the mobile station 250.

After receiving the context of the mobile station 250 from the macro base station 150, the control unit 303 of each of the small base stations 350 determines whether handover of the mobile station 250 can be accepted. If the handover can be accepted, the transmission unit 301 notifies the macro base station 150 that the acceptance is approved.

Thereafter, when the reception unit 302 receives a handover request from the mobile station 250, the transmission unit 301 notifies the mobile station 250 that the handover has been approved. Thereafter, when the reception unit 302 receives notification of completion of handover from the mobile station 250, the transmission unit 301 notifies the macro base station 150 of release of a resource.

When starting handover, the control unit 203 of the mobile station 250 cancels the dual access connection and switches to connection only with the macro base station 150 acting as the primary base station.

Upon completion of handover from the macro base station 150 to the small base station 350, the control unit 203 switches to dual access connection where, while the small base station 350 having transitioned to a serving base station operates as the primary base station, another one of the small base stations 350 operates as the secondary base station.

The transmission unit 201, on the basis of the most recent results of measurement of reception qualities, selects one of the small base stations 350 as the destination-side base station, from the small base stations 350 that are destination-side candidate base stations indicated by the notification from the macro base station 150.

The transmission unit 201 then transmits a handover request to the small base station 350 that is the destination-side base station. Thereafter, when the reception unit 202 receives the notification of approval of handover from the small base station 350 that is the destination-side base station, the transmission unit 201 transmits notification of completion of handover to the small base station 350 that is the destination-side base station.

After the completion of the handover, the transmission unit 201 and the reception unit 202 perform communication while connecting in a dual-access manner to the small base station 350 that is the destination-side base station operating as the primary base station and also to another one of the small base stations 350 operating as the secondary base station.

The present embodiment has been described by way of an exemplary case where the mobile station 250 is handed over starting from a state connected to the macro base station 150 operating as the primary base station and the small base station 350 operating as the secondary base station in a dual-access manner, so as to enter into a state having the small base station 350 as the primary base station. However, the condition of handover is not limited to this example, and the present embodiment is applicable regardless of which of the macro base station 150 and the small base station 350 operates as the primary base station when the mobile station 250 connects thereto in a dual-access manner. The present embodiment is also applicable regardless of which of the macro base station 150 and the small base station 350 is the handover destination.

As described above, in the radio communication system according to the present embodiment, the destination-side base station in handover is determined by a mobile station by use of the most recent reception qualities while the mobile station connects in a dual-access manner. The radio communication system according to the present embodiment can improve the success rate of handover even in the case where a mobile station connects in a dual-access manner.

Although the case of connection in a dual-access manner has been given as an example in at least one of the respective embodiments described above, the respective embodiments are operable likewise and bring about the same effects even in the case of a system that does not involve connection in a dual-access manner. For example, in the third embodiment, the destination-side base station in handover is determined by a mobile station by use of the most recent reception qualities even in a system that does not involve connection in a dual-access manner. More specifically, the success rate of handover can be improved even in the case of the radio communication system according to the third embodiment that does not involve connection in a dual-access manner.

One aspect of the radio communication system, the base station, the mobile station, and the radio communication method disclosed herein brings about an effect of improving the success rate of handover. The embodiments discussed herein are not limited to the above objective. Bringing about functions and effects that are obtained by the respective configurations of the above described embodiments and that are not enabled by conventional techniques can be considered as another objective of the embodiments.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication system comprising a plurality of first radio communication devices and a second radio communication device,
the first radio communication devices each comprising:
a control unit that, when the second radio communication device is currently connected to the first radio communication device which has the control unit, notifies the first radio communication devices other than the first radio communication device of information on the second radio communication device; and
a first transmission unit that transmits, to the second radio communication device, information on the first radio communication devices which have been notified of the information on the second radio communication device,
the second radio communication device comprising:
a second transmission unit that selects, on the basis of the information on the first radio communication devices which has been transmitted from the first transmission unit, one of the first radio communication devices which have been notified of the information on the second radio communication device and transmits to the selected first radio communication device a control signal for controlling handover.

2. The radio communication system according to claim 1, wherein
on the basis of a radio quality between the second radio communication device and each of the first radio communication devices which are surrounding the second radio communication device, the control unit transmits the information on the second radio communication device to two or more of the first radio communication devices which are surrounding the second radio communication device, and
on the basis of replies transmitted in response to the information transmitted by the control unit, the first transmission unit selects candidate devices as a plurality of potential handover destinations, and transmits information on the candidate devices to the second radio communication device.

3. The radio communication system according to claim 2, wherein
upon receiving the information on the second radio Communication device from the first radio communication device to which the second radio communication device is currently connected, when the second radio communication device has a state in which a handover of the first radio communication device to which the second radio communication device is currently connected is accepted, the control unit notifies the first radio communication device to which the second radio communication device is currently connected that the handover can be accepted, and
the first transmission unit selects, as the candidate devices, the selected first radio communication devices which have transmitted the notification indicating that the handover can be accepted.

4. The radio communication system according to claim 2, wherein
the second radio communication device further comprises a measurement unit that measures a radio quality between the second radio communication device and each of the surrounding first radio communication devices, and
the second transmission unit transmits, to the first radio communication device to which the second radio communication device is currently connected, a result of the measurement by the measurement unit.

5. A base station comprising:
a control unit that, when a mobile station is currently connected to the base station, notifies a plurality of base stations other than the base station of information on the mobile station, the mobile station comprising a communication unit that selects, on the basis of information on a plurality of base stations, one of these base stations and transmits to the selected base station a control signal for controlling handover; and
a transmission unit that transmits, to the mobile station, information on the base stations which have been notified of the information on the mobile station.

6. A mobile station comprising a transmission unit that selects one base station on the basis of information on a plurality of other base stations which has been transmitted from a first base station, and transmits to the selected base station a control signal for controlling handover, the first base station comprising: a control unit that, when the mobile station is currently connected to the first base station, notifies the other base stations of information on the mobile station; and a transmission unit that transmits, to the mobile station, information on the other base stations which have been notified of the information on the mobile station.

7. A communication method in a radio communication system comprising a plurality of first radio communication devices and a second radio communication device, the communication method comprising:
by one of the first radio communication devices to which the second radio communication device is being connected, notifying the first radio communication devices other than the first radio communication devices of information on the second radio communication device, and transmitting, to the second radio communication device, first information on the first radio communication devices which have been notified of the information on the second radio communication device; and
by the second radio communication device, on the basis of the first information transmitted from the foregoing one of the first radio communication devices, selecting one of the first radio communication devices and transmitting, to the selected first radio communication device, a control signal for controlling handover.
